(19) United States
(12) Patent Application Publication
(10) Pub. No.: US 2025/0138606 A1
(43) Pub. Date: May 1, 2025

(54) WATER COOLING HEAD ASSEMBLY WITH HEAT PIPE COMBINED WITH MULTI-LAYER HEAT-CONDUCTING STRUCTURE

(71) Applicant: Huizhou Xunshuo Technology Co., Ltd, Huizhou (CN)

(72) Inventors: Fuyin Wang, Huizhou (CN); Yanzhun Lian, Huizhou (CN)

(21) Appl. No.: 18/397,733

(22) Filed: Dec. 27, 2023

(30) Foreign Application Priority Data
Oct. 25, 2023 (CN) 202322877540.5

(51) Int. Cl. G06F 1/20

(52) U.S. Cl. CPC G06F 1/20; G06F 2200/201

(57) ABSTRACT

A water cooling head assembly with a heat pipe combined with a multi-layer heat-conducting structure includes a water pump. A multi-layer heat-conducting structure is arranged below a water pump bottom housing, and at least one heat pipe is arranged above and below the multi-layer heat-conducting structure; the multi-layer heat-conducting structure includes a multi-layer heat-conducting structure top layer, a multi-layer heat-conducting structure main body, a multi-layer heat-conducting structure interlayer and a multi-layer heat-conducting structure bottom layer; and multi-layer heat sink fins are arranged inside the multi-layer heat-conducting structure. Absorbing heat by means of a contact surface of a bottom layer, the heat pipe conducts the heat upward, and the multi-layer heat-conducting structure interlayer and the water pump bottom housing are utilized to dissipate heat, enhancing the heat dissipation efficiency in the limited space and at a rated flow rate.

### CROSS-REFERENCE TO RELATED APPLICATIONS

This application claims priority of Chinese Patent Application No. 202322877540.5, filed on Oct. 25, 2023, the entire contents of which are incorporated herein by reference.

### TECHNICAL FIELD

The present disclosure relates to the field of radiators, in particular to a water cooling head assembly with a heat pipe combined with a multi-layer heat-conducting structure.

### BACKGROUND

A radiator, as a device used to conduct and release heat, is often used in computer equipment, mechanical equipment and heating equipment. The equipment will generate a large amount of heat during operation, and the heat is quickly dissipated by means of the radiator to avoid accumulation, ensuring the normal operation of the equipment.

A water cooling head is a component commonly used in the radiator. In the prior art, a heat dissipation structure for the water cooling head is mostly a heat dissipation structure with single-layer fins. Limited by the single-layer fin structure, the heat dissipation ability can only be enhanced by increasing a size or increasing a flow rate, but the increase of the space or power consumption imposes a burden on users. Therefore, a heat dissipation structure different from the traditional structure with single-layer fins is required to improve the heat dissipation effect in limited space and at the same flow rate.

### SUMMARY

An objective of the present disclosure is to provide a water cooling head assembly with a heat pipe combined with a multi-layer heat-conducting structure to overcome the shortcomings in the prior art.

The objective of the present disclosure is realized by the following technical solutions.

A water cooling head assembly with a heat pipe combined with a multi-layer heat-conducting structure includes a water pump. A water pump bottom housing is arranged below the water pump; a multi-layer heat-conducting structure is arranged below the water pump bottom housing; and a heat-conducting bottom housing is arranged below the multi-layer heat-conducting structure. The water pump drives a water-cooled liquid to flow into the multi-layer heat-conducting structure from the water pump bottom housing to absorb heat and dissipate heat, and then to flow out from the water pump to circulate, realizing water-cooled heat dissipation. At least one heat pipe is arranged above the multi-layer heat-conducting structure, the heat pipe above fills a gap between the multi-layer heat-conducting structure and the water pump bottom housing, and assists in heat dissipation by transferring part of the heat to the water pump bottom housing, enhancing the heat dissipation capacity of a water cooling head. At least one heat pipe is arranged below the multi-layer heat-conducting structure, the heat pipe below fills a gap between the multi-layer heat-conducting structure and the heat-conducting bottom housing, and conducts the heat from the heat-conducting bottom housing to the multi-layer heat-conducting structure interlayer, realizing multi-layer heat dissipation, and improving the heat dissipation efficiency. The multi-layer heat-conducting structure includes a multi-layer heat-conducting structure top layer, a multi-layer heat-conducting structure main body, a multi-layer heat-conducting structure interlayer and a multi-layer heat-conducting structure bottom layer from top to bottom, and multi-layer heat sink fins are arranged inside the multi-layer heat-conducting structure to quickly conduct the heat of the water-cooled liquid.

In one example, the heat pipe is U-shaped with the multi-layer heat-conducting structure clamped inside the U-shape. Four heat pipes are arranged, and the heat pipe is made of a high heat-conducting material.

In one example, the multi-layer heat sink fin includes top layer heat sink fins, interlayer heat sink fins and bottom layer heat sink fins, the top layer heat sink fins being arranged between the multi-layer heat-conducting structure top layer and the multi-layer heat-conducting structure main body, the interlayer heat sink fins being arranged between the multi-layer heat-conducting structure main body and the multi-layer heat-conducting structure interlayer, and the bottom layer heat sink fins being arranged between the multi-layer heat-conducting structure interlayer and the multi-layer heat-conducting structure bottom layer. This design can fully utilize the space above to improve the heat dissipation efficiency while maintaining the same size.

In one example, two groups of top layer heat sink fins are arranged, the two groups of top layer heat sink fins being fixed on two sides of a lower portion of the multi-layer heat-conducting structure top layer; two groups of interlayer heat sink fins are arranged, the two groups of interlayer heat sink fins being fixed on two sides of an upper portion of the multi-layer heat-conducting structure interlayer, and the interlayer heat sink fins being trapezoidal; and the bottom layer heat sink fins are fixed in a middle of an upper portion of the multi-layer heat-conducting structure bottom layer. When dissipating heat, the water-cooled liquid and the heat pipe conduct heat to the top layer heat sink fins, the interlayer heat sink fins and the bottom layer heat sink fins, realizing multi-layer heat dissipation, increasing the heat dissipation area and improving the heat dissipation efficiency.

In one example, the multi-layer heat-conducting structure top layer and the multi-layer heat-conducting structure main body form a second chamber, the multi-layer heat-conducting structure top layer being a rectangular plate with a rectangular hollowed outlet in the middle, and the multi-layer heat-conducting structure main body being shaped as a cross-like column and having a rectangular hollow in the middle; and the multi-layer heat-conducting structure main body, the multi-layer heat-conducting structure interlayer and the multi-layer heat-conducting structure bottom layer form a first chamber, the multi-layer heat-conducting structure interlayer being a cross-shaped plate matched with the multi-layer heat-conducting structure main body with a rectangular hollow in the center, a water-cooled liquid channel being arranged next to the interlayer heat sink fins, and the multi-layer heat-conducting structure bottom layer being a cross-shaped plate with a downward recessed center.

In one example, the water pump is disposed with a water pump inlet and a water pump outlet; the water pump bottom housing is disposed with a water pump bottom housing inlet and a water pump bottom housing outlet, a water pump bottom housing inlet channel being L-shaped, and after flowing into which, the water-cooled liquid flowing downward; and the multi-layer heat-conducting structure is disposed with a multi-layer heat-conducting structure inlet and a multi-layer heat-conducting structure outlet, the multi-layer heat-conducting structure inlet being located at one end of the cross, the multi-layer heat-conducting structure outlet being a rectangular channel, and a wider outlet being capable of enhancing the flow speed of the water-cooled liquid. A water flow flows into the multi-layer heat-conducting structure inlet through the water pump bottom housing inlet, flows out through the multi-layer heat-conducting structure outlet after flowing into the second chamber through the first chamber, and flows out through the water pump outlet after flowing into the water pump inlet through the water pump bottom housing outlet. The water-cooled liquid flows into from the multi-layer heat-conducting structure inlet and absorbs heat from the bottom heat sink fins and the interlayer heat sink fins, and conducts part of the heat to the top layer heat sink fins when passing through the top layer heat sink fins, and the top layer heat sink fins conduct the heat through the heat pipe to the water pump bottom housing, and the water pump bottom housing uses its large area and water pump bottom housing heat sink fins to dissipate heat.

In one example, water pump bottom housing heat sink fins are arranged on an outer side of the water pump bottom housing. The water pump bottom housing heat sink fins are located at an outer ring of a lower portion of the water pump bottom housing, which can increase the heat dissipation area to assist a water cooling heat to dissipate heat.

In one example, the water pump is arranged with water pump fixed columns, the water pump bottom housing is arranged with water pump bottom housing fixed columns, the water pump fixed columns being matched with the water pump bottom housing fixed columns to fix the water pump and the water pump bottom housing.

In one example, a bracket I and a bracket II are arranged between the water pump bottom housing and the heat-conducting bottom housing. The bracket I and the bracket II are fixedly assembled on the water cooling head, and the water cooling head is fixed above a heat source by fixing the brackets.

The present disclosure has the following advantageous effects.

According to the present disclosure, by adopting the above technical solutions, the contact surface of the multi-layer heat-conducting structure bottom layer can absorb heat from the heat source, and the heat pipe below is utilized to conduct the heat to the multi-layer heat-conducting structure interlayer, thereby increasing the area of heat absorption and improving the efficiency of heat absorption. Moreover, the multi-layer heat-conducting structure top layer conducts part of the heat to the water pump bottom housing through the heat pipe, and the water pump bottom housing heat sink fins are used to assist heat dissipation. The heat dissipation space above is fully utilized by means of the multi-layer structure, which improves the heat dissipation efficiency in the limited space and at a rated flow rate.

### BRIEF DESCRIPTION OF THE DRAWINGS

In order to describe the technical solutions in the examples of the present disclosure more clearly, the accompanying drawings required for the examples are briefly described below. It is to be understood that the accompanying drawings in the following show merely some examples of the present disclosure, and are not to be deemed as limiting the scope. Those of ordinary skill in the art can also derive other accompanying drawings from these accompanying drawings without creative efforts.

FIG. 1 is an exploded view of the present disclosure.

FIG. 2 is a perspective view of a water pump.

FIG. 3 is a perspective view of a water pump bottom housing.

FIG. 4 is an exploded view of a multi-layer heat-conducting structure.

FIG. 5 is a perspective view of the multi-layer heat-conducting structure.

FIG. 6 is a top view of the multi-layer heat-conducting structure.

FIG. 7 is a cross-sectional view of FIG. 6 along AA.

FIG. 8 is a cross-sectional view of FIG. 6 along BB.

FIG. 9 is a perspective view of the present disclosure.

FIG. 10 is a cross-sectional view of FIG. 9 along CC.

FIG. 11 is a cross-sectional view of FIG. 9 along DD.

Reference numerals and denotations thereof: 1—water pump; 2—water pump bottom housing; 3—multi—layer heat—conducting structure; 4—heat pipe; 5—heat—conducting bottom housing; 6—bracket I; 7—bracket II; 8—water pump inlet; 9—water pump outlet; 10—water pump fixed column; 11—water pump bottom housing inlet; 12—water pump bottom housing outlet; 13—water pump bottom housing fixed column; 14—multi—layer heat—conducting structure inlet; 15—multi—layer heat—conducting structure outlet; 16—multi—layer heat—conducting structure top layer; 17—multi—layer heat—conducting structure main body; 18—multi—layer heat—conducting structure interlayer; 19—multi—layer heat—conducting structure bottom layer; 20—top layer heat sink fin; 21—interlayer heat sink fin; 22—bottom layer heat sink fin; 23—first chamber; 24—second chamber; and 25—water pump bottom housing heat sink fin.

### DETAILED DESCRIPTION

For the ease of understanding the present disclosure, the present disclosure will be described more comprehensively by reference to the related drawings below. The preferred embodiments of the present disclosure are provided in the accompanying drawings. However, the present disclosure can be realized in various forms and is not limited to the embodiments described herein. These embodiments are provided for the purpose of making the content disclosed by the present disclosure more thorough and comprehensive.

It is to be noted that when an element is “fixed” to another element, it can be fixed directly or by means of a middle element to another element. When an element is “connected to” another element, it can be connected to another element directly or by means of a middle element. The terms “vertical,” “horizontal,” “left,” “right,” and similar expressions used herein are for illustrative purposes merely and are not intended to be a sole embodiment.

Unless otherwise specified, all technical and scientific terms used herein have the same meaning as those generally understood by ordinary skilled in the art to which the present disclosure belongs. The terms used herein in the specification of the present disclosure are merely illustrative of the specific embodiments, and are not to be deemed as limiting the present disclosure. The term “and/or” includes any and all combinations of one or more related listed items.

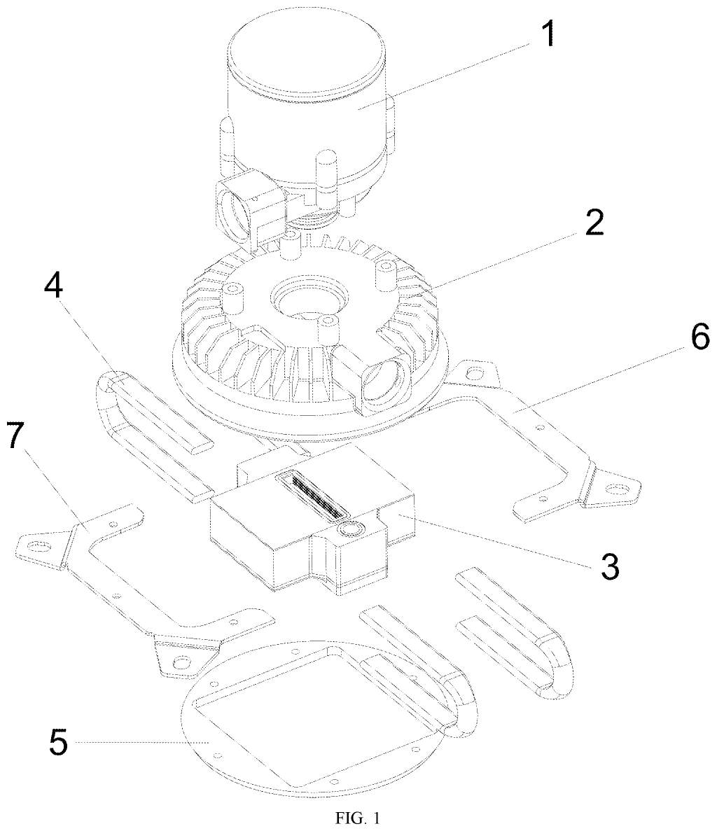

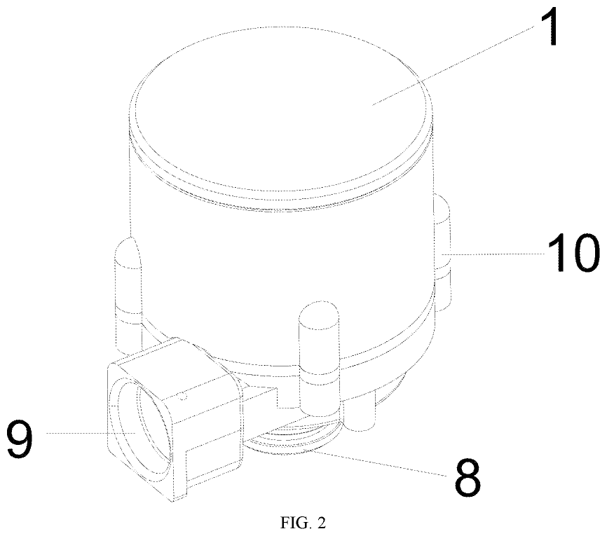

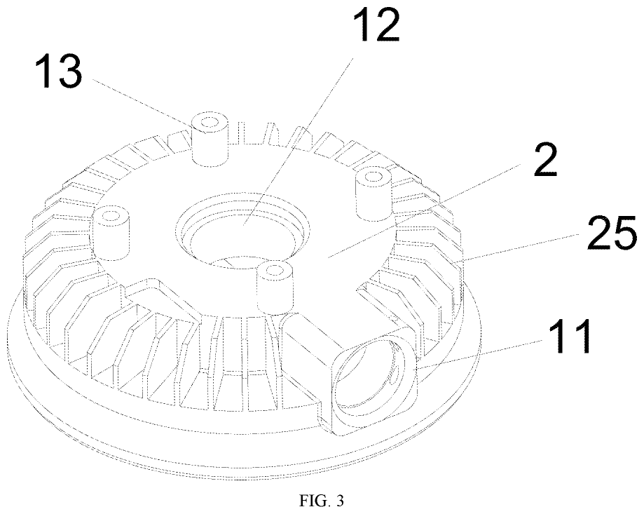

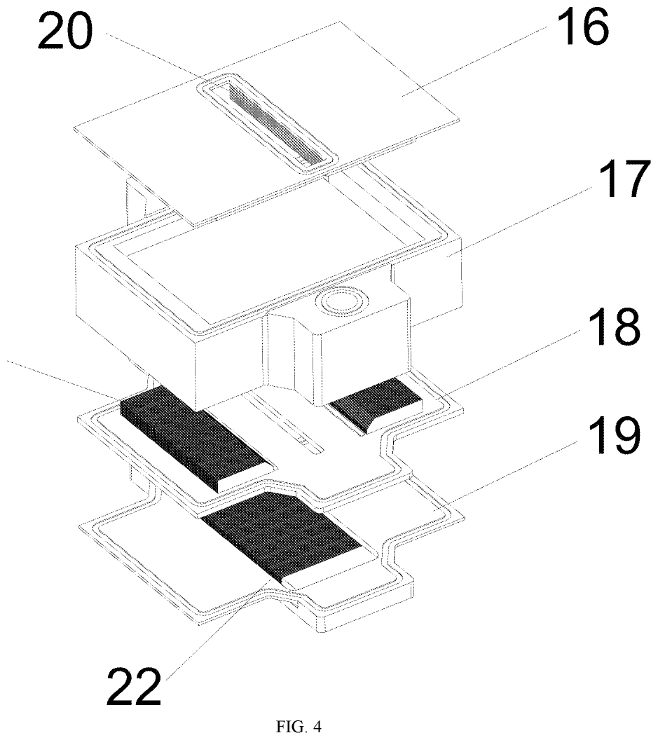

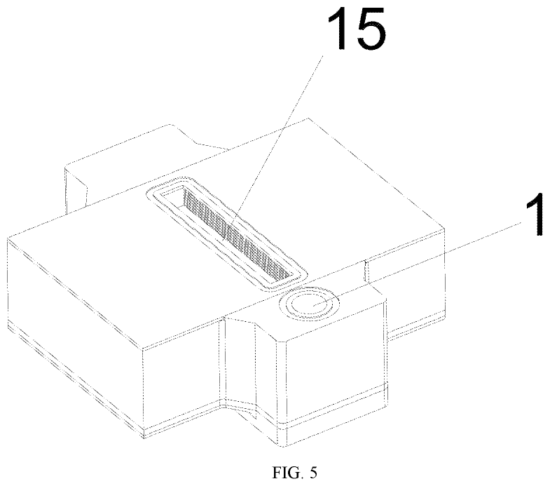

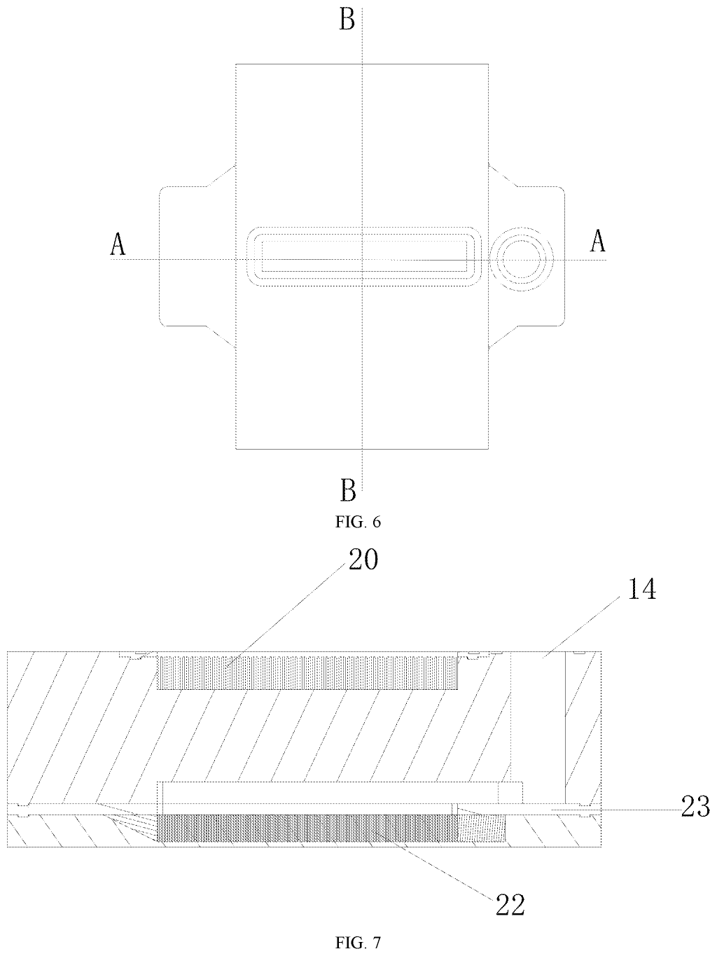

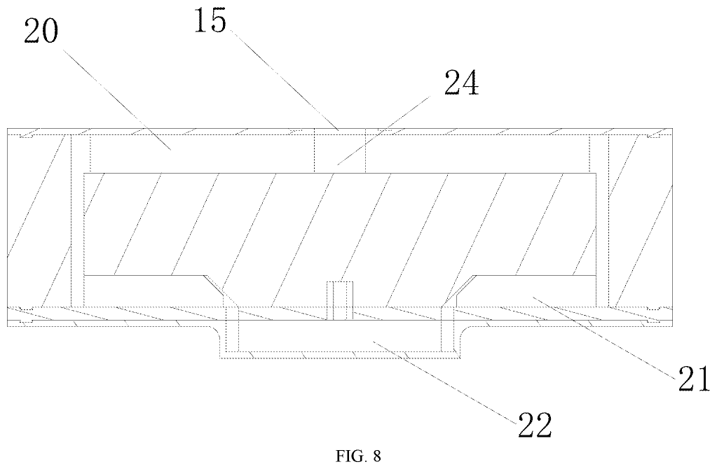

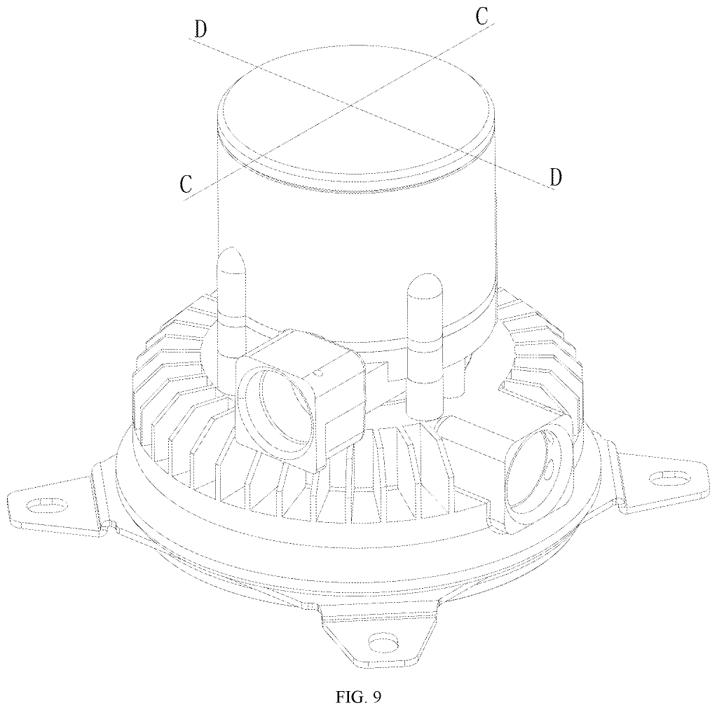

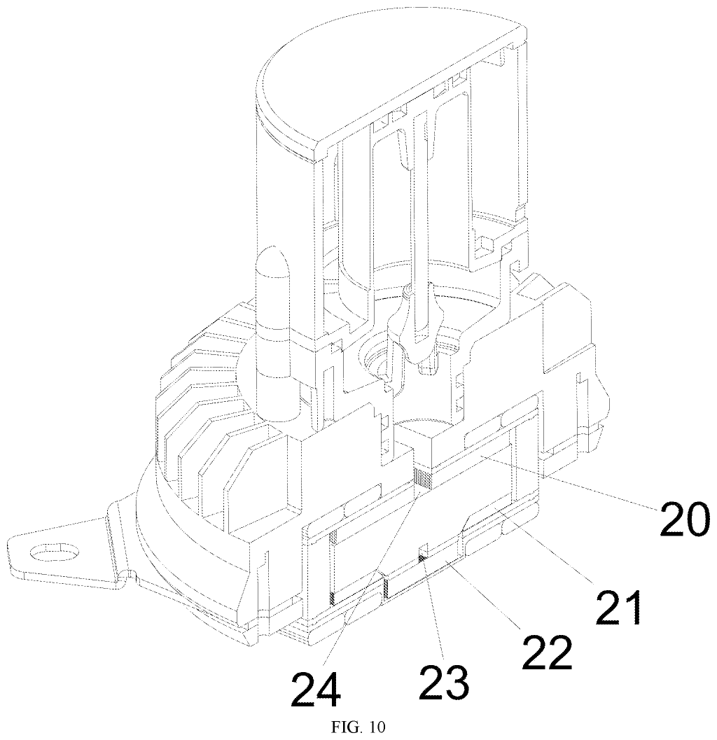

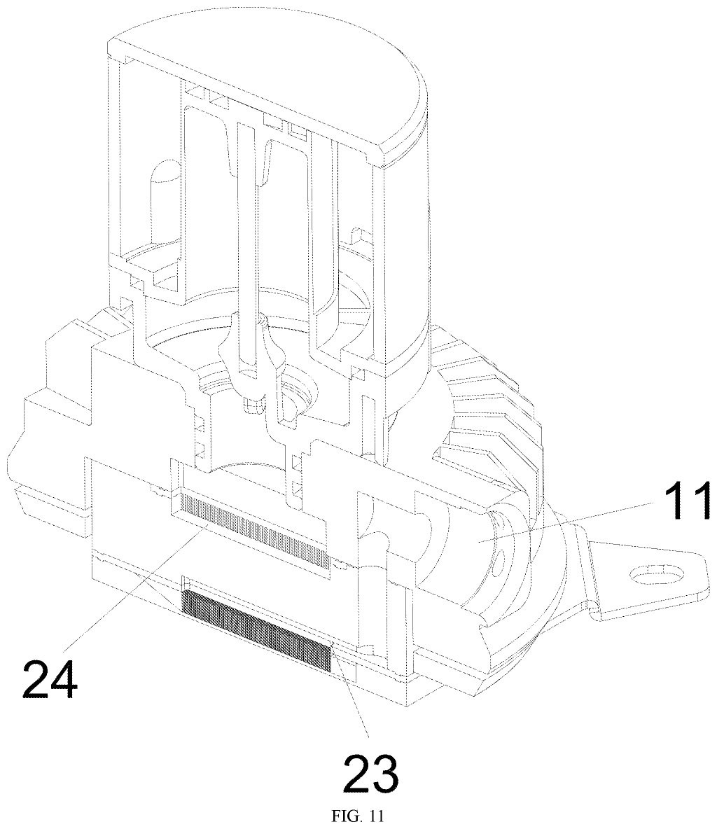

Examples of the present disclosure are described by reference to FIGS. 1 to 11.

A water cooling head assembly with a heat pipe combined with a multi-layer heat-conducting structure includes a water pump 1. A water pump bottom housing 2 is arranged below the water pump 1; a multi-layer heat-conducting structure 3 is arranged below the water pump bottom housing 2; a heat-conducting bottom housing 5 is arranged below the multi-layer heat-conducting structure 3; at least one heat pipe 4 is arranged above the multi-layer heat-conducting structure 3; at least one heat pipe 4 is arranged below the multi-layer heat-conducting structure 3; the multi-layer heat-conducting structure 3 includes a multi-layer heat-conducting structure top layer 16, a multi-layer heat-conducting structure main body 17, a multi-layer heat-conducting structure interlayer 18 and a multi-layer heat-conducting structure bottom layer 19 from top to bottom; and multi-layer heat sink fins are arranged inside the multi-layer heat-conducting structure 3.

By adopting the above technical solution, the water pump 1 drives a water-cooled liquid from the water pump bottom housing 2 into the multi-layer heat-conducting structure 3 to absorb heat and dissipate heat and then flow out from the water pump 1 to circulate, realizing water-cooled heat dissipation; the heat pipe 4 above the multi-layer heat-conducting structure 3 fills a gap between the multi-layer heat-conducting structure 3 and the water pump bottom housing 2, and transfers part of the heat to the pump bottom housing 2 to assist heat dissipation, enhancing a heat dissipation capacity of a water cooling head; the heat pipe 4 below the multi-layer heat-conducting structure 3 fills a gap between the multi-layer heat-conducting structure 3 and the heat-conducting bottom housing 5, and conducts the heat from the heat-conducting bottom housing 5 to the multi-layer heat-conducting structure interlayer 18, realizing multi-layer heat dissipation and improving the heat dissipation efficiency; the multi-layer heat-conducting structure 3 includes the multi-layer heat-conducting structure top layer 16, the multi-layer heat-conducting structure main body 17, the multi-layer heat-conducting structure interlayer 18 and the multi-layer heat-conducting structure bottom layer 19 from top to bottom, forming multi-chamber layered heat dissipation, and making full use of the space above to increase the heat dissipation area and improve the heat dissipation efficiency; and the multi-layer heat sink fins are arranged inside the multi-layer heat-conducting structure 3 to quickly conduct the heat of the water-cooled liquid.

Preferably, the heat pipe 4 is U-shaped, and four heat pipes 4 are arranged.

By adopting the above technical solution, the multi-layer heat-conducting structure 3 is clamped inside the four U-shaped heat pipes 4, and the heat pipe 4 is made of a high heat-conducting material to better transfer heat upward and downward.

Preferably, the multi-layer heat sink fin includes top layer heat sink fins 20, interlayer heat sink fins 21 and bottom layer heat sink fins 22, the top layer heat sink fins 20 being arranged between the multi-layer heat-conducting structure top layer 16 and the multi-layer heat-conducting structure main body 17, the interlayer heat sink fins 21 being arranged between the multi-layer heat-conducting structure main body 17 and the multi-layer heat-conducting structure interlayer 18, and the bottom layer heat sink fins 22 being arranged between the multi-layer heat-conducting structure interlayer 18 and the multi-layer heat-conducting structure bottom layer19.

By adopting the above technical solution, the top layer heat sink fins 20 arranged between the multi-layer heat-conducting structure top layer 16 and the multi-layer heat-conducting structure main body 17 conduct heat upward; the interlayer heat sink fins 21 arranged between the multi-layer heat-conducting structure main body 17 and the multi-layer heat-conducting structure interlayer 18 absorb the heat transferred by the heat pipe 4; and the bottom layer heat sink fins 22 arranged between the multi-layer heat-conducting structure interlayer 18 and the multi-layer heat-conducting structure bottom layer 19 absorb heat from a heat source. The design can fully utilize the space above to improve the heat dissipation efficiency while maintaining the same size.

Preferably, two groups of top layer heat sink fins 20 are arranged, the two groups of top layer heat sink fins 20 being fixed on two sides of a lower portion of the multi-layer heat-conducting structure top layer 16, two groups of interlayer heat sink fins 21 are arranged, the two groups of interlayer heat sink fins 21 being fixed on two sides of an upper portion of the multi-layer heat-conducting structure the interlayer 18, and the bottom layer heat sink fins 22 are fixed in a middle of an upper portion of the multi-layer heat-conducting structure bottom layer 19.

By adopting the above technical solution, the two groups of top layer heat sink fins 20 have a larger heat dissipation area and a higher heat dissipation efficiency; the two groups of interlayer heat sink fins 21 have a larger heat dissipation area and a higher heat dissipation efficiency, the interlayer heat sink fins 21 are trapezoidal, and the shape of which matches with the multi-layer heat dissipation structure main body; the bottom layer heat sink fins 22 are arranged above the multi-layer heat-conducting structure bottom layer 19 to absorb heat; and a water-cooled liquid and the heat pipe 4 conduct the heat to the top layer heat sink fins 20, the interlayer heat sink fins 21, and the bottom layer heat sink fins 22 when dissipating the heat, realizing multi-layer heat dissipation, increasing the heat dissipation area and improving the heat dissipation efficiency.

Preferably, the multi-layer heat-conducting structure top layer 16 and the multi-layer heat-conducting structure main body 17 form a second chamber 24, and the multi-layer heat-conducting structure main body 17, the multi-layer heat-conducting structure interlayer 18 and the multi-layer heat-conducting structure bottom layer 19 form a first chamber 23.

By adopting the above technical solution, the first chamber 23 and the second chamber 24 increase the heat dissipation area and improve the heat dissipation efficiency.

Preferably, the water pump 1 is disposed with a water pump inlet 8 and a water pump outlet 9. The water pump bottom housing 2 is disposed with a water pump bottom housing inlet 11 and a water pump bottom housing outlet 12. The multi-layer heat-conducting structure 3 is disposed with a multi-layer heat-conducting structure inlet 14 and a multi-layer heat-conducting structure outlet 15. A water flow flows into the multi-layer heat-conducting structure inlet 14 through the water pump bottom housing inlet 11, flows out through the multi-layer heat-conducting structure outlet 15 after flowing into the second chamber 24 through the first chamber 23, and flows out through the water pump outlet 9 after flowing into the water pump inlet 8 through the water pump bottom housing outlet 12.

By adopting the above technical solution, an L-shaped water pump bottom housing inlet 11 channel makes the water-cooled liquid flow downward after entering; the multi-layer heat-conducting structure inlet 14 is located at one end of the cross, the multi-layer heat-conducting structure outlet 15 is a rectangular channel, and a wider outlet can enhance the flow speed of the water-cooled liquid; the water-cooled liquid flows into the multi-layer heat-conducting structure inlet 14 through the pump bottom housing inlet 11, flows out through the multi-layer heat-conducting structure outlet 15 after flowing into the second chamber 24 through the first chamber 23, and flows out through the water pump water outlet 9 after flowing into the water pump inlet 8 through the water pump bottom housing outlet 12 to circulate to realize the flow; and the water-cooled liquid flows into through the multi-layer heat-conducting structure inlet 14 and absorbs the heat from the bottom heat sink fins 22 and the interlayer heat sink fins 21, and conducts part of the heat to the top layer heat sink fins 20 when passing through the top layer heat sink fins 20, and the top layer heat sink fins 20 conduct the heat through the heat pipe 4 to the water pump bottom housing 2, and the water pump bottom housing 2 uses its large area and water pump bottom housing heat sink fins 25 to dissipate heat.

Preferably, water pump bottom housing heat sink fins 25 are arranged on an outer side of the water pump bottom housing 2.

By adopting the above technical solution, the water pump bottom housing heat sink fins 25 at an outer ring of the water pump bottom housing 2 increases the heat dissipation area and assists the water cooling head to dissipate heat.

Preferably, the water pump 1 is arranged with water pump fixed columns 10, and the water pump bottom housing 2 is arranged with water pump bottom housing fixed columns 13, the water pump fixed columns 10 being matched with the water pump bottom housing fixed columns 13.

By adopting the above technical solution, the water pump fixed column 10 is matched with the water pump bottom housing fixed column 13 to fix the water pump 1 and the water pump bottom housing 2.

Preferably, a bracket I 6 and a bracket II 7 are arranged between the water pump bottom housing 2 and the heat-conducting bottom housing 5.

By adopting the above technical solution, the bracket I 6 and the bracket II 7 are fixedly assembled on the water cooling head, and the water cooling head is fixed above the heat source by means of fixing the brackets when in use.

An operation principle is as follows. Utilizing the combination of the heat pipe 4 and the multi-layer heat-conducting structure 3, the heat pipe 4 below transmits heat from the heat source to the multi-layer heat-conducting structure bottom layer 19 and the multi-layer heat-conducting structure interlayer 18, so that the water-cooled liquid quickly absorbs heat when it passes through. When the water-cooled liquid passes through the second chamber 24, the top layer heat sink fin 20 of the multi-layer heat-conducting structure top layer transmits the heat to the water pump bottom housing 2 through the heat pipe 4 above, and the water pump bottom housing heat sink fins 25 are utilized to assist heat dissipation. The design of the multi-layer structure makes full use of the space above, which improves the heat dissipation efficiency of the water cooling head.

When mounting, the water cooling head is aligned with the heat source and is fixed above the heat source by means of the brackets to complete the mounting.

The examples described above are merely several embodiments of the present disclosure, which are described in a more specific and detailed manner, but are not to be construed as a limitation on the scope of the present disclosure. It is to be noted that for those ordinary skilled in the art, several deformations and improvements can be made without departing from the conception of the present disclosure, all of which fall within the scope of protection of the present disclosure. Therefore, the scope of protection of the present disclosure is to be defined by the attached claims.

1. A water cooling head assembly with a heat pipe combined with a multi-layer heat-conducting structure, comprising a water pump (1), wherein a water pump bottom housing (2) is arranged below the water pump (1); a multi-layer heat-conducting structure (3) is arranged below the water pump bottom housing (2); a heat-conducting bottom housing (5) is arranged below the multi-layer heat-conducting structure (3); at least one heat pipe (4) is arranged above the multi-layer heat-conducting structure (3); at least one heat pipe (4) is arranged below the multi-layer heat-conducting structure (3); the multi-layer heat-conducting structure (3) comprises a multi-layer heat-conducting structure top layer (16), a multi-layer heat-conducting structure main body (17), a multi-layer heat-conducting interlayer (18) and a multi-layer heat-conducting structure bottom layer (19) from top to bottom; and multi-layer heat sink fins are arranged inside the multi-layer heat-conducting structure (3).

2. The water cooling head assembly with a heat pipe combined with a multi-layer heat-conducting structure according to claim 1, wherein the heat pipe (4) is U-shaped.

3. The water cooling head assembly with a heat pipe combined with a multi-layer heat-conducting structure according to claim 1, wherein the multi-layer heat sink fin comprises top layer heat sink fins (20), interlayer heat sink fins (21) and bottom layer heat sink fins (22), the top layer heat sink fins (20) being arranged between the multi-layer heat-conducting structure top layer (16) and the multi-layer heat-conducting structure main body (17), the interlayer heat sink fins (21) being arranged between the multi-layer heat-conducting structure main body (17) and the multi-layer heat-conducting structure interlayer (18), and the bottom layer heat sink fins s (22) being arranged between the multi-layer heat-conducting structure interlayer (18) and the multi-layer heat-conducting structure bottom layer (19).

4. The water cooling head assembly with a heat pipe combined with a multi-layer heat-conducting structure according to claim 3, wherein two groups of top layer heat sink fins (20) are arranged, the two groups of top layer heat sink fins (20) being fixed on two sides of a lower portion of the multi-layer heat-conducting structure top layer (16), two groups of interlayer heat sink fins (21) are arranged, the two groups of interlayer heat sink fins (21) being fixed on two sides of an upper portion of the multi-layer heat-conducting structure interlayer (18), and the bottom layer heat sink fins (22) are fixed in a middle of an upper portion of the multi-layer heat-conducting structure bottom layer (19).

5. The water cooling head assembly with a heat pipe combined with a multi-layer heat-conducting structure according to claim 1, wherein the multi-layer heat-conducting structure top layer (16) and the multi-layer heat-conducting structure main body (17) form a second chamber (24), and the multi-layer heat-conducting structure main body (17), the multi-layer heat-conducting structure interlayer (18) and the multi-layer heat-conducting structure bottom layer (19) form a first chamber (23).

6. The water cooling head assembly with a heat pipe combined with a multi-layer heat-conducting structure according to claim 5, wherein the water pump (1) is disposed with a water pump inlet (8) and a water pump outlet (9), the water pump bottom housing (2) is disposed with a water pump bottom housing inlet (11) and a water pump bottom housing outlet (12), and the multi-layer heat-conducting structure (3) is disposed with a multi-layer heat-conducting structure inlet (14) and a multi-layer heat-conducting structure outlet (15), a water flow flowing into the multi-layer heat-conducting structure inlet (14) through the water pump bottom housing inlet (11), flowing out through the multi-layer heat-conducting structure outlet (15) after flowing into the second chamber (24) through the first chamber (23), and flowing out through the water pump outlet (9) after flowing into the water pump inlet (8) through the water pump bottom housing outlet (12).

7. The water cooling head assembly with a heat pipe combined with a multi-layer heat-conducting structure according to claim 1, wherein water pump bottom housing heat sink fins (25) are arranged on an outer side of the water pump bottom housing (2).

8. The water cooling head assembly with a heat pipe combined with a multi-layer heat-conducting structure according to claim 1, wherein the water pump (1) is arranged with water pump fixed columns (10), and the water pump bottom housing (2) is arranged with water pump bottom housing fixed columns (13), the water pump fixed columns (10) being matched with the water pump bottom housing fixed columns (13).

9. The water cooling head assembly with a heat pipe combined with a multi-layer heat-conducting structure according to claim 1, wherein a bracket I (6) and a bracket II (7) are arranged between the water pump bottom housing (2) and the heat-conducting bottom housing (5).
